(19) United States
(12) Patent Application Publication
(10) Pub. No.: US 2016/0238480 A1
(43) Pub. Date: Aug. 18, 2016

(54) SEAL VACUUM CHECK TOOL

(71) Applicant: United Technologies Corporation, Hartford, CT (US)

(72) Inventors: Pawel Socha, Manchester, CT (US); Peter S. Matteson, South Windsor, CT (US); John Pergantis, Manchester, CT (US); Anthony Valenti, Wolcott, CT (US)

(21) Appl. No.: 14/623,329

(22) Filed: Feb. 16, 2015

(51) Int. Cl. G01M 3/02; G01M 3/28

(52) U.S. Cl. CPC G01M 3/025; G01M 3/2869

(57) ABSTRACT

Aspects of the disclosure are directed to installing a test assembly on an aircraft engine, connecting a vacuum source to at least one port of the test assembly, engaging the vacuum source, and based on determining that a vacuum is maintained in an amount greater than a threshold, determining that a plurality of seals are present in the engine.

### BACKGROUND

An aircraft engine utilizes an oil system for purposes of cleaning, cooling, and lubricating components or devices, such as bearings Tubes are used to convey the oil between a first device (e.g., a bearing or bearing housing) and a second device (e.g., a pump, such as an oil pump or scavenge pump).

Multiple seals associated with the tubes follow a so-called “blind procedure” in terms of assembly, in the sense that once the oil system is assembled it cannot be determined/verified whether a technician has installed the seals. A pressure-based test can be used to determine whether a single seal is present, but is ineffective to verify that all the seals are present and installed/functioning properly. If a seal is absent or not functioning properly, an oil leak internal to the engine may develop.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure are directed to a method comprising: installing a test assembly on an aircraft engine, connecting a vacuum source to at least one port of the test assembly, engaging the vacuum source, and based on determining that a vacuum is maintained in an amount greater than a threshold, determining that a plurality of seals are present in the engine. In some embodiments, the seals are associated with a tube that is used to convey a fluid. In some embodiments, the fluid comprises oil. In some embodiments, the tube is a double-wall tube comprising a first wall that is exterior to a second wall. In some embodiments, the seals comprise a first seal that provides sealing in an axial direction with respect to the engine. In some embodiments, the seals comprise a second seal that provides sealing in a radial direction with respect to the engine.

Aspects of the disclosure are directed to a test assembly configured to determine whether a plurality of seals are present in an aircraft engine, comprising: a first o-ring, a second o-ring, a cap, and a port configured to couple to a vacuum source. In some embodiments, the first o-ring is configured to provide sealing with respect to an external environment. In some embodiments, the second o-ring is configured to provide for sealing with respect to a portion of a tube that is internal to a wall. In some embodiments, at least one of the first o-ring and the second o-ring is made of fluorocarbon. In some embodiments, the cap is made of metal. In some embodiments, the cap is made of at least one of aluminum or steel. In some embodiments, the cap is configured to seal an internal passage of a tube. In some embodiments, the cap is configured to seal an outer portion of the tube from the atmosphere.

Aspects of the disclosure are directed to a system associated with an aircraft engine, comprising: a double-wall tube configured to convey oil, at least two seals associated with the tube, and a test assembly configured to couple to the engine and used to determine whether the at least two seals are present based on an applied vacuum source. In some embodiments, the system further comprises the vacuum source. In some embodiments, the double-wall tube comprises a first wall and a second wall, and wherein a cavity is formed between the first wall and the second wall, and wherein the test assembly is configured to attempt to pull air through the at least two seals via the cavity. In some embodiments, the double-wall tube is made of at least one of stainless steel, a nickel-chromium based alloy, or titanium.

### BRIEF DESCRIPTION OF THE DRAWINGS

The present disclosure is illustrated by way of example and not limited in the accompanying figures in which like reference numerals indicate similar elements.

FIG. 1 is a side cutaway illustration of a geared turbine engine.

FIG. 2 illustrates a system comprising a tube for conveying fluid and a plurality of seals.

FIG. 3 illustrates a system comprising a test assembly for testing the seals of the system of FIG. 2.

FIG. 4 illustrates a flow chart of an exemplary method for testing a plurality of seals.

### DETAILED DESCRIPTION

It is noted that various connections are set forth between elements in the following description and in the drawings (the contents of which are included in this disclosure by way of reference). It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities.

In accordance with various aspects of the disclosure, apparatuses, systems and methods are described for testing to ensure that a plurality of seals are present and installed/functioning properly. In some embodiments, a test assembly/fixture is applied (e.g., bolted onto) an engine, next a test is performed to verify the seals, and then the test assembly is removed from the engine. The test assembly may include at least one of an o-ring, a cap, or a vacuum pump.

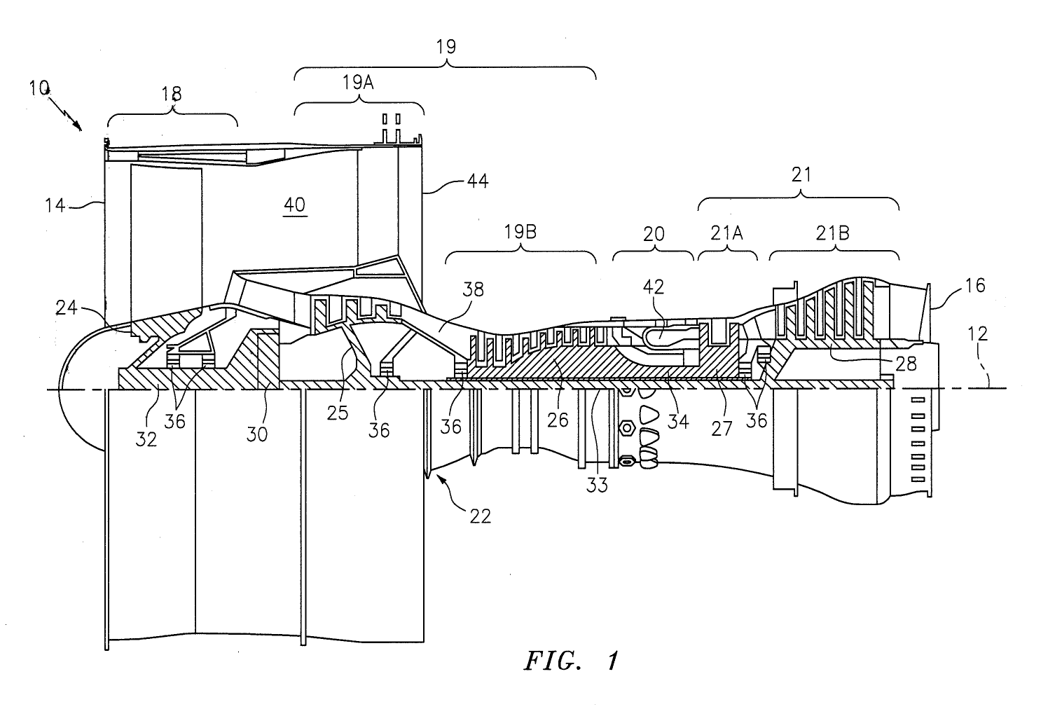

FIG. 1 is a side cutaway illustration of a geared turbine engine 10. This turbine engine 10 extends along an axial centerline 12 between an upstream airflow inlet 14 and a downstream airflow exhaust 16. The turbine engine 10 includes a fan section 18, a compressor section 19, a combustor section 20 and a turbine section 21. The compressor section 19 includes a low pressure compressor (LPC) section 19A and a high pressure compressor (HPC) section 19B. The turbine section 21 includes a high pressure turbine (HPT) section 21A and a low pressure turbine (LPT) section 21B.

The engine sections 18-21 are arranged sequentially along the centerline 12 within an engine housing 22. Each of the engine sections 18-19B, 21A and 21B includes a respective rotor 24-28. Each of these rotors 24-28 includes a plurality of rotor blades arranged circumferentially around and connected to one or more respective rotor disks. The rotor blades, for example, may be formed integral with or mechanically fastened, welded, brazed, adhered and/or otherwise attached to the respective rotor disk(s).

The fan rotor 24 is connected to a gear train 30, for example, through a fan shaft 32. The gear train 30 and the LPC rotor 25 are connected to and driven by the LPT rotor 28 through a low speed shaft 33. The HPC rotor 26 is connected to and driven by the HPT rotor 27 through a high speed shaft 34. The shafts 32-34 are rotatably supported by a plurality of bearings 36; e.g., rolling element and/or thrust bearings. Each of these bearings 36 is connected to the engine housing 22 by at least one stationary structure such as, for example, an annular support strut.

During operation, air enters the turbine engine 10 through the airflow inlet 14, and is directed through the fan section 18 and into a core gas path 38 and a bypass gas path 40. The air within the core gas path 38 may be referred to as “core air”. The air within the bypass gas path 40 may be referred to as “bypass air”. The core air is directed through the engine sections 19-21, and exits the turbine engine 10 through the airflow exhaust 16 to provide forward engine thrust. Within the combustor section 20, fuel is injected into a combustion chamber 42 and mixed with compressed core air. This fuel-core air mixture is ignited to power the turbine engine 10. The bypass air is directed through the bypass gas path 40 and out of the turbine engine 10 through a bypass nozzle 44 to provide additional forward engine thrust. This additional forward engine thrust may account for a majority (e.g., more than 70 percent) of total engine thrust. Alternatively, at least some of the bypass air may be directed out of the turbine engine 10 through a thrust reverser to provide reverse engine thrust.

The engine 10 is illustrative. Aspects of the disclosure may be applied in connection with other engine types or configurations. One or more frames may be used to support the section(s) 19 and/or the section(s) 21.

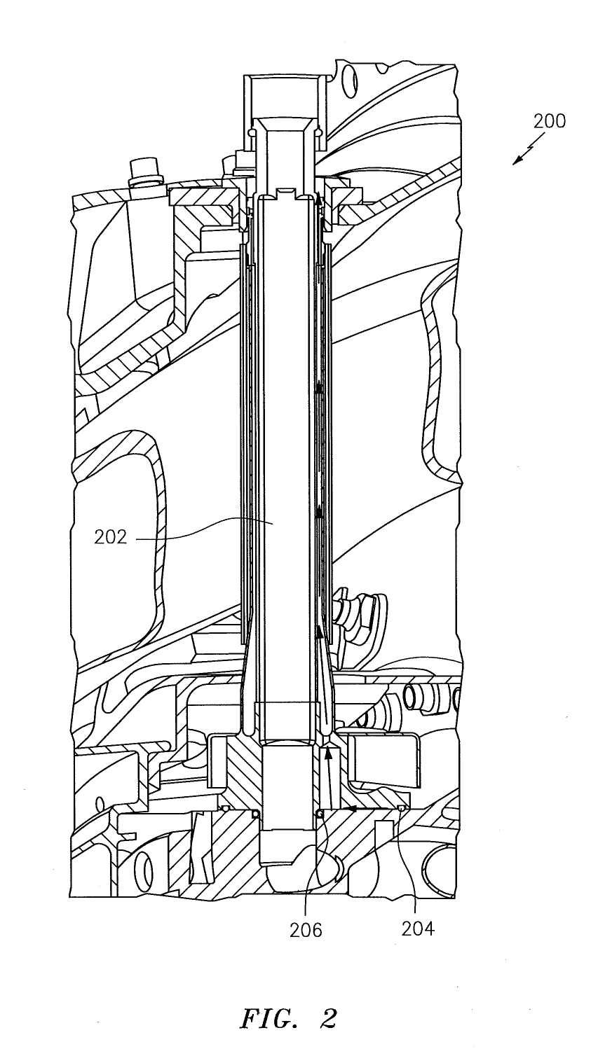

Referring now to FIG. 2, a system 200 in accordance with an embodiment of this disclosure is shown. The system 200 may be associated with an engine, such as the engine 10 described above in connection with FIG. 1.

The system 200 may include a tube 202 that may be used for conveying a fluid (e.g., oil). For example, the tube 202 may convey fluid between a first device (e.g., a bearing or bearing compartment) and a second device (e.g., a pump, such as an oil pump or scavenge pump). As described further below, the tube 202 may be a double-wall tube in the sense that it may include a first and a second wall. The first wall may be outside of, or exterior to, the second wall.

Associated with the tube 202 may be one or more seals. For example, a first seal 204 may provide sealing in an axial direction (e.g., oriented in the direction of the axial centerline 12 of FIG. 1) with respect to the engine. A second seal 206 may provide sealing in a radial direction (e.g., perpendicular to the axial centerline 12 of FIG. 1) with respect to the engine. The seal 204 and/or the seal 206 may include a c-seal.

Once the system 200 is assembled, it may be difficult to determine/verify whether both the seal 204 and the seal 206 are present and installed/functioning properly using conventional techniques. The absence or ineffectiveness of one or both of the seals 204 and 206 could lead to a potential leak of fluid.

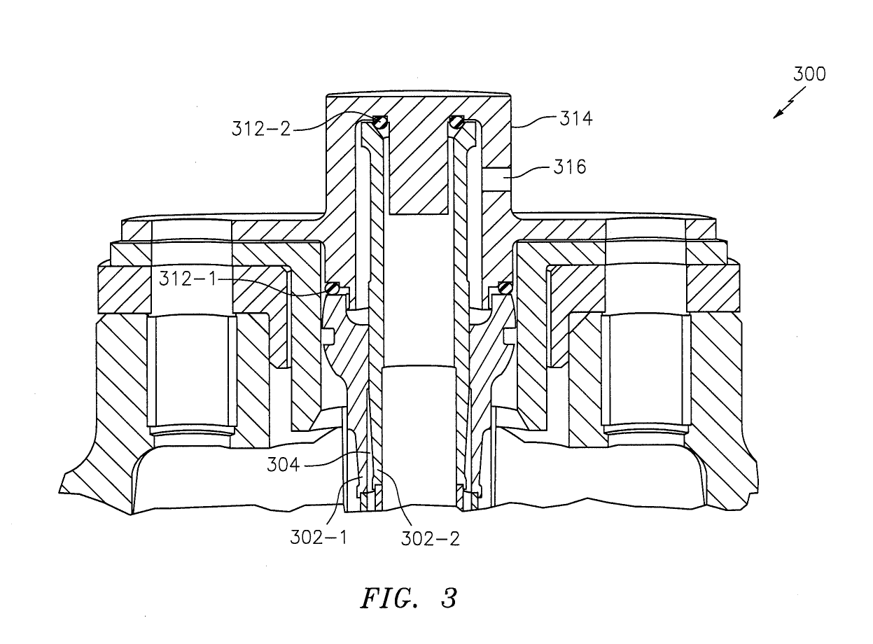

Referring now to FIG. 3, a system 300 is shown. The system 300 may include an outer wall 302-1 and an inner wall 302-2 of a tube (e.g., the tube 202 of FIG. 2). The walls 302-1 and 302-3 are made of stainless steel, a nickel-chromium based alloy (e.g., Inconel) or titanium in some embodiments. A cavity 304 may be formed or defined between the walls 302-1 and 302-2. The cavity 304 ordinarily may serve as a channel for conveying fluid. In this respect, the walls 302-1 and 302-2 may be leak-tight in the sense that the fluid may be retained within the cavity 304.

Referring to FIGS. 2-3, during a test of the system 200, a test assembly may be utilized to determine the presence and functionality of the seals 204 and 206. This test assembly may include a first o-ring 312-1 and a second o-ring 312-2. The o-ring 312-1 may provide for sealing with respect to the outside/external environment, e.g., the atmosphere. The o-ring 312-2 may provide for sealing with respect to the portion of the tube that is internal to the wall 302-2. The o-rings 312-1 and 312-2 may be made of one or more materials, such as for example fluorocarbon. The o-rings may be obtained commercially and may be an off-the-shelf product. In some embodiments, a seal or face-seal may be used, potentially in lieu of using an o-ring.

The test assembly may include a cap 314. The cap 314 may be made of one or more materials, such as for example metal (e.g., aluminum, steel, etc.). The cap 314 may seal the internal passage of the tube through which fluid would normally flow. The cap 314 may seal the outer portion of the tube from the atmosphere. In this manner, the cap 314 may provide for additional sealing beyond that provided by the o-rings 312-1 and 312-2.

The test assembly may include a port 316. The port 316 may be used for applying/connecting a vacuum as described below.

Once the test assembly is applied/installed, a vacuum source (not shown) that may be connected at the port 316 may attempt to pull air through both of the seals 204 and 206 via the cavity 304. If both seals 204 and 206 are present and installed/functioning properly a vacuum may be maintained. If one or both of the seals 204 and 206 are absent or installed/functioning improperly, a vacuum may not be achieved/maintained. Thus, the presence of a maintained vacuum in an amount greater than a threshold may serve as verification that the seals 204 and 206 are present and installed/functioning properly.

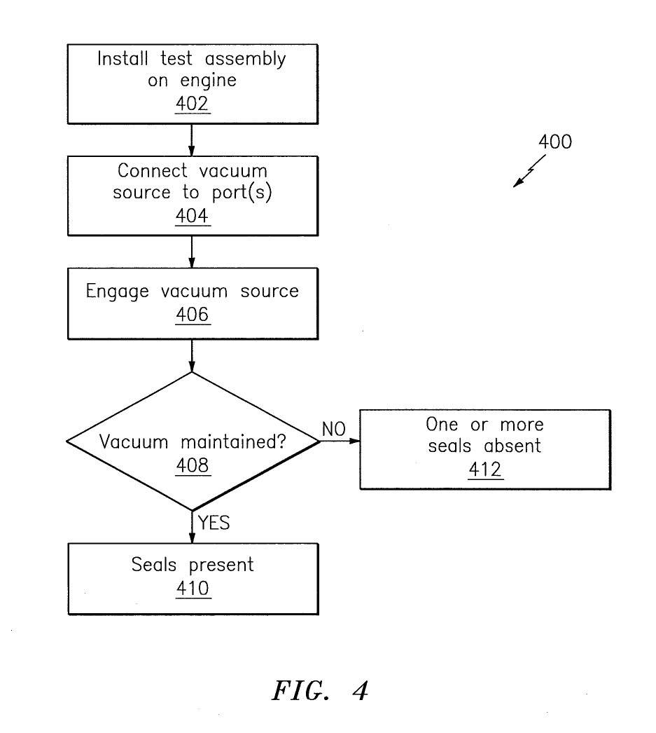

Referring now to FIG. 4, a method 400 in accordance with aspects of the disclosure is shown. The method 400 may be applied in connection with, e.g., the system 200 and/or the system 300 described above. The method 400 may be used to test one or more seals, e.g., the seals 204 and 206.

In block 402, a test assembly may be applied/installed to an engine.

In block 404, a source of a vacuum may be connected to the test assembly at one or more ports.

In block 406, the vacuum source may be turned on or engaged in an attempt to establish and maintain a vacuum.

In block 408, a determination may be made whether a vacuum was established/maintained in connection with block 406. If so, a determination may be made that the seals are present and installed/functioning properly in block 410. Otherwise, a determination be made that one or more of the seals are absent or installed/functioning improperly in block 412.

Technical effects and benefits of this disclosure include enhanced efficiency in terms of testing one or more seals in connection with bearing tubes. Aspects of the disclosure enable a testing of seals prior to an engine run or full engine assembly. Accordingly, any potential fault or defect in a seal may be detected as early as possible, thereby minimizing/reducing the likelihood that disassembly will be needed in the field (e.g., following engine deployment).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional in accordance with aspects of the disclosure. One or more features described in connection with a first embodiment may be combined with one or more features of one or more additional embodiments.

What is claimed is:

1. A method comprising:
installing a test assembly on an aircraft engine;
connecting a vacuum source to at least one port of the test assembly;
engaging the vacuum source; and
based on determining that a vacuum is maintained in an amount greater than a threshold, determining that a plurality of seals are present in the engine.

2. The method of claim 1, wherein the seals are associated with a tube that is used to convey a fluid.

3. The method of claim 2, wherein the fluid comprises oil.

4. The method of claim 2, wherein the tube is a double-wall tube comprising a first wall that is exterior to a second wall.

5. The method of claim 1, wherein the seals comprise a first seal that provides sealing in an axial direction with respect to the engine.

6. The method of claim 5, wherein the seals comprise a second seal that provides sealing in a radial direction with respect to the engine.

7. A test assembly configured to determine whether a plurality of seals are present in an aircraft engine, comprising:
a first o-ring;
a second o-ring;
a cap; and
a port configured to couple to a vacuum source.

8. The test assembly of claim 7, wherein the first o-ring is configured to provide sealing with respect to an external environment.

9. The test assembly of claim 7, wherein the second o-ring is configured to provide for sealing with respect to a portion of a tube that is internal to a wall.

10. The test assembly of claim 7, wherein at least one of the first o-ring and the second o-ring is made of fluorocarbon.

11. The test assembly of claim 7, wherein the cap is made of metal.

12. The test assembly of claim 7, wherein the cap is made of at least one of aluminum or steel.

13. The test assembly of claim 7, wherein the cap is configured to seal an internal passage of a tube.

14. The test assembly of claim 13, wherein the cap is configured to seal an outer portion of the tube from the atmosphere.

15. A system associated with an aircraft engine, comprising:
a double-wall tube configured to convey oil;
at least two seals associated with the tube; and
a test assembly configured to couple to the engine and used to determine whether the at least two seals are present based on an applied vacuum source.

16. The system of claim 15, further comprising the vacuum source.

17. The system of claim 15, wherein the double-wall tube comprises a first wall and a second wall, and wherein a cavity is formed between the first wall and the second wall, and wherein the test assembly is configured to attempt to pull air through the at least two seals via the cavity.

18. The system of claim 15, wherein the double-wall tube is made of at least one of stainless steel, a nickel-chromium based alloy, or titanium.
